(19) United States
(12) Patent Application Publication
(10) Pub. No.: US 2025/0125749 A1
(43) Pub. Date: Apr. 17, 2025

(54) CONTROLLER FOR A MOTORIZED AWNING SYSTEM

(71) Applicant: Steiner Enterprises, Lafayette, IN (US)

(72) Inventors: Joshua E. DeWitt, Westfield, IN (US); Thomas P. Hicks, Lafayette, IN (US); Donald E. DeWitt, Syracuse, IN (US)

(21) Appl. No.: 18/917,033

(22) Filed: Oct. 16, 2024

Related U.S. Application Data
(60) Provisional application No. 63/544,475, filed on Oct. 17, 2023.

(51) Int. Cl. H02P 7/29; B60P 3/34; B60R 16/03; H02P 7/292; H02P 29/68

(52) U.S. Cl. CPC H02P 7/29; B60P 3/343; B60R 16/03; H02P 7/292; H02P 29/68

(57) ABSTRACT

A motor controller for a drive motor of an RV awning system, increases the voltage provided to the motor from the RV power supply to a boosted voltage, to increase the speed of the motor and thereby reduce the amount of time required to deploy or retract the awning. The motor controller includes a microprocessor control unit that uses a PWM control signal to linearly increase the current to the drive motor to achieve a soft start for the motor and reduce the risk of an overcurrent condition. The motor controller is configured to be added to an existing awning switch to easily increase the operating speed of an existing awning drive motor. The motor controller includes a housing with a flange that rests on the lower ledge of the switch opening formed in the outer wall of the RV.

### PRIORITY CLAIM

This application is a utility filing from and claims priority to U.S. Provisional Application No. 63/544,475, filed on Oct. 17, 2023, the entire disclosure of which is specifically incorporated herein by reference.

### BACKGROUND

The present disclosure relates to motorized awning systems, particularly for use with recreational vehicles.

A common feature for recreational vehicles (RVs) is an awning system. As illustrated in FIG. 1, the awning system S includes an awning A in the form of a flexible sheet with one end anchored to the RV and the opposite end rolled up on a roller R. An articulating frame F supports the roller R so that of the awning overhangs the side of the RV in the deployed position. In the stowed position, the awning is wound fully onto the roller and the roller is retracted against the RV. An upgraded awning system includes an electric motor associated with the roller R and/or articulating frame F that deploys and retracts the awning A, typically against the force of a biasing spring. The drive motor for the awning is connected to the electrical system of the vehicle at a standard RV voltage, typically +12 Vdc.

A switch is provided that activates the motor to extend or retract the awning. The typical switch is held by the user until a sensor determines that the awning has reached the end of its travel. Since the awning drive motor is only powered at the RV voltage (i.e., 12 Vdc), the speed of the motor is limited, leading to a travel time of about 35 seconds to deploy and about 40 seconds to retract. For a single awning this length of time that the user must hold the switch is not unduly burdensome. However, many RVs include multiple awnings, and often four awnings with two on each side of the RV. In that case, the length of time that it takes to move all of the awnings can exceed two minute, which can be extremely annoying to the RVer and in some cases risky, such as when the awnings need to be quickly retracted due to the onset of harsh weather conditions.

There is a need for an awning motor control system that can meaningfully reduce the amount of time that it takes to extend and retract the RV awning.

### SUMMARY

An improvement is provided for a recreational vehicle (RV) having an electrical system and an RV power supply to power the electrical system at an RV voltage, and an awning system having an extendable awning, a drive motor for extending the awning, and a user-actuated switch for activating the motor. The improvement comprises a motor controller that can replace the existing motor controller and that can increase the operating speed of the drive motor as it deploys or retracts the awning. In one feature, the motor controller includes a booster circuit connected to RV power supply and configured to increase the RV voltage to a boosted voltage at a booster output; an output control circuit connecting the booster output to the drive motor and controlled by a pulse-width modulated (PWM) signal to control the current provided to the output motor; and a microprocessor control unit (MCU) connected to the user-actuated switch and configured to provide the PWM signal to the output control circuit when and as long as the switch is actuated by the user. In one example, the RV voltage is a standard 12 Vdc and the booster circuit is configured to increase that voltage to a boosted voltage of 24V. In one aspect, the PWM signal is adapted to linearly increase the current from zero amps to a maximum current for the RV electrical system to provide a soft start for the drive motor.

In another improvement the motor controller includes wiring to connect to the RV power supply, the existing switch and the existing drive motor; and a housing containing the MCU and other electrical circuits, in which the housing includes a mounting bracket at a top end of the housing that is configured to rest on a lower ledge of the switch opening in the RV wall when the switch is mounted within the switch opening. The motor controller disclosed herein can thus easily replace an existing motor controller or can be integrated into the circuitry connecting the switch and power supply to the drive motor.

### BRIEF DESCRIPTION OF THE DRAWINGS

FIG. 1 a perspective view of a recreational vehicle (RV) with a motor-driven awning system.

FIG. 2 a perspective view of the motor controller of the present disclosure.

FIG. 3 a side partial cross-sectional view of the motor controller of FIG. 2 mounted within the switch opening in a wall of the RV.

FIG. 4 is a diagrammatic view of one embodiment of the motor controller.

FIG. 5 is a perspective view of a wiring interface of the motor controller shown in FIG. 4.

FIG. 6 is a circuit diagram of a microprocessor control unit (MCU) of the present motor controller.

FIG. 7 is a circuit diagram of a booster circuit of the present motor controller.

FIG. 8 is a circuit diagram of a current measurement circuit of the present motor controller.

FIG. 9 is a circuit diagram of an output control circuit of the present motor controller.

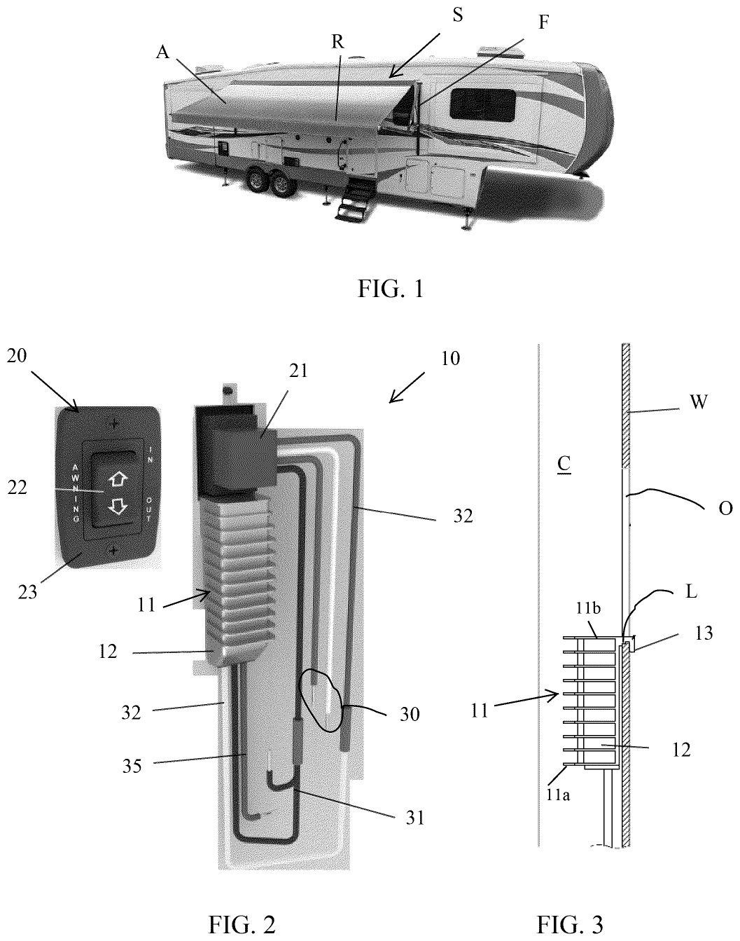

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

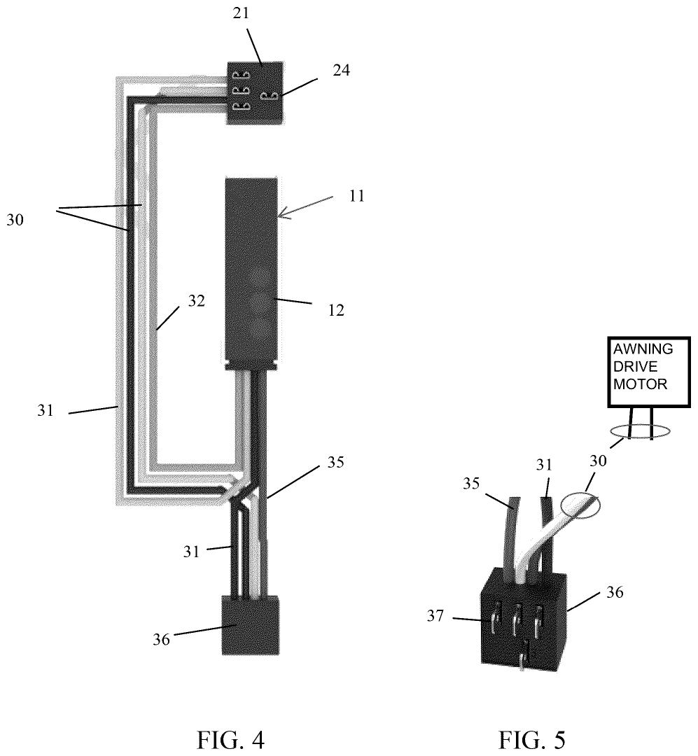

A motor control assembly 10 is provided for controlling the motor (not shown) of a motorized awning system, particularly for an RV. The assembly includes a motor controller 11 connected to a switch 20, as shown in FIGS. 2-3. The motor controller includes a housing 12 that contains the electronics for the controller, including a printed circuit board that includes an electronic control unit (ECU). The housing can include radiator fins 11a projecting from the outer surface of the housing to help dissipate heated generated by the electrical components within the housing. The housing 12 includes a mounting bracket 13 at the top end 11a of the housing that is configured to rest on the lower ledge L of a switch opening O formed in an outer wall W of the RV. The opening is configured to receive the switch 20 mounted therein in a conventional manner. The switch 20 (FIG. 4) can include a receptacle 21 that supports the switch buttons 22 and the wire terminals 24 and any electrical components associated with the switch. It is understood that the wire terminals can be plug-in type, as shown in FIG. 4, wire nuts, or any other suitable means to connect the wires to the switch 20. The receptacle 21 is configured to be mounted to the wall W of the RV at a switch opening O. A face plate 23 is fastened to the receptacle in a conventional manner and arranged to cover the opening O in the wall W. It can be appreciated that the switch receptacle 21 and the motor controller 11 reside within the wall cavity C and that the switch buttons 22 and face plate 23 are on the opposite side of the wall W for access by the user.

The mounting bracket 13 of the motor controller can be integrally formed with the housing 12, as illustrated in FIG. 2. The bracket is strong enough to support the motor controller without the need for additional fasteners. The bracket is sized to be received with a conventionally-sized wall opening, with the width of the bracket being slightly less than the width of the opening O. The wall opening O can be the opening provided for an existing motor control switch. In this instance, the switch 20 can be the existing switch for the awning system, or can be a replacement switch, such as the switch shown in FIG. 2. The presence of the mounting bracket allows the motor controller 11 of the present disclosure to be integrated into the wiring for the existing motorized awning. The housing 12 of the motor controller is thus sized to be introduced through the switch opening O into the wall cavity C to seat the mounting bracket 13 on the lower ledge L of the opening.

The switch 20 is connected to the awning motor by wires 30 engaged to wire clips within the switch receptacle 21. The switch is also connected to a ground wire 31, along with the motor controller 11. The switch 20 receives a voltage signal from the controller 11 on output wire 32. The controller is connected to the RV power supply by a power input wire 35. The controller 11 is connected to the RV power supply at the RV voltage on wire 35 to provide the speed control feature described herein.

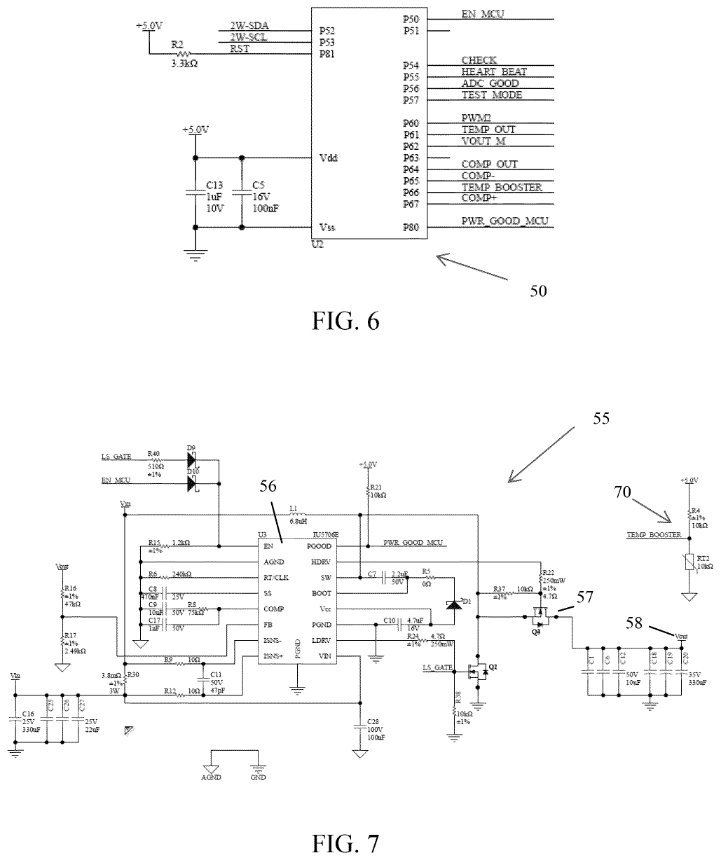

The controller 11 includes the electronics and circuitry shown in FIGS. 6-9. The controller includes a microprocessor control unit (MCU) 50 that includes a microprocessor configured to execute instructions for generating a pulse-width modulated (PWM) control signal and other control signals for controlling the electrical power supplied to the drive motor after actuation of the switch 20. The MCU 50 remains in a sleep mode until it receives a +5V signal at the CHECK node (P54) from the switch 20 when the switch is actuated by the user. The MCU continuously monitors the CHECK node to verify that the switch is still actuated by the user. If the user releases the switch, the voltage at the CHECK node goes to zero, in which case the MCU deactivates the controller 11.

When the controller 11 is activated by the user (i.e., a voltage at the CHECK node is detected), the MCU 50 enables a booster circuit 55 shown in FIG. 7, by applying a +5V signal at node EN_MCU The booster circuit 55 is configured to receive the RV voltage of the vehicle power system on wire 35 and increase it to an enhanced voltage signal at the booster output 56 to be supplied to the drive motor of the awning system through wires 30. As explained above, the RV power supply powers the awning drive motor at the RV voltage that runs the motor at a speed found to be unsatisfactory to RV′ers. Since the rotational speed of an electric motor is directly proportional to the voltage provided to the motor, the speed of the awning drive motor can be increased by increasing the voltage provided to the motor. The booster circuit 55 thus takes the RV voltage from the RV power supply and amplifies it to a boosted voltage, which can increase the speed capability of the motor since motor speed is directly proportional to the voltage applied to the motor. In a typical RV electrical system, the power supply is at 12 Vdc. In one embodiment, the booster circuit 55 can be configured to increase the RV voltage (12 Vdc) to a boosted voltage of 24 Vdc or even 48 Vdc. The boosted voltage can be based on the rated voltage of the motor.

The booster circuit includes a microprocessor 56 that receives an enabling signal from the MCU 50 at node EN_MCU, and is operable to activate mosfet 57 to supply the boosted signal at the booster output 58. If the CHECK node of the MCU goes to zero, the MCU 50 disables the EN_MCU signal within 10 seconds, thereby disabling the booster circuit 55.

With the switch 20 actuated, the MCU monitors the booster output 58 as it drives the voltage up from the RV voltage (such as 12 Vdc) to the boosted voltage (such as 24 Vdc). In particular, when the voltage reaches boosted voltage (such as 24 Vdc), the microprocessor 56 of the booster circuit issues a PWR_GOOD_MCU signal that is received by the MCU 50. The MCU then applies a pulse-width modulated signal PWM2 to an output control circuit 65 shown in FIG. 9 to control the current that is provided to the awning drive motor. With the output control circuit 65 receives the boosted voltage signal from the booster circuit and provides the output electrical power signal at output 66 to the drive motor wires 30 to power the awning motor. The output control circuit receives a PWM2 signal from the MCU that ramps up the current at the output 66 to provide a soft start to the awning drive motor. In particular, the PWM signal linearly increases the current from zero amps to the maximum value, such as 15 amps, over a predetermined time interval. In one embodiment, the predetermined time interval is 1 second for the soft start, although slightly longer time intervals can be implemented. The soft start ensures that the boosted voltage does not drive the current provided to the awning motor beyond the maximum value as the drive motor accelerates to its maximum speed. The PWM2 signal maintains the power provided to the drive motor at the maximum current as long as certain operating conditions are met or until certain error or fault conditions arise.

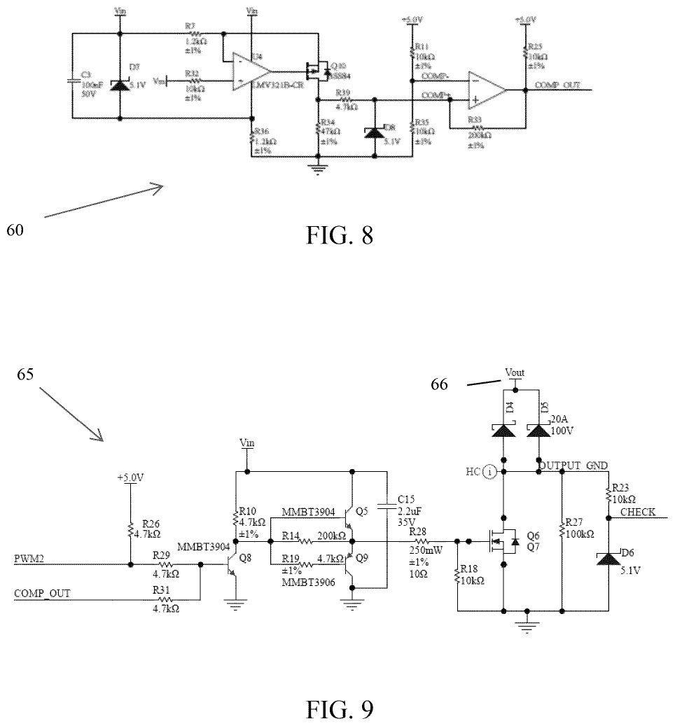

For most RV electrical systems, the wiring has a maximum allowable current capacity, namely 15 amps. The controller 11 thus include a current measurement circuit 60 shown in FIG. 8. It is known that for a fixed voltage, the load current will increase as the load on the motor is increased. Thus, if the awning motor experiences an increased load as it is accelerating to its maximum speed, the load current can increase above the maximum allowable current for the RV electrical system. The current measurement circuit 60 compares the load current of the electrical signal provided by the booster circuit 50 to the threshold current of a baseline signal. The threshold current can be the 15 amp limit, or a lower value such as 14.5 amps. The circuit 60 provides a +5V COMP_OUT signal to the MCU if the incoming current exceeds the threshold. Upon receipt of this signal, the MCU 50 disables the booster circuit 55 as well as the output PWM2 signal to the output control circuit.

The controller 11 also includes a thermistor at the booster circuit 55, such as thermistor 70 as shown in FIG. 7, and at the output control circuit (not shown). The two thermistors provide a TEMP_BOOSTER signal and a TEMP_OUT signal, respectively, to the MCU 50 that compares the two temperature signals to a threshold value, such as 100° C. If either temperature exceeds the threshold, the MCU disables the booster circuit 55 and the output control circuit 65.

The controller 11 can incorporate a time-based safety check using firmware to keep track of the amount of time the motor is running after activation by the MCU. The MCU monitors this time and if it exceeds a run-time threshold, the MCU disables the booster circuit 55 and the output control circuit 65 for a fixed time period, such as 30 seconds, before reactivating the two circuits and the awning drive motor.

The controller 11 continuously monitors the operating conditions of the voltage booster circuit 55 during the operation of the awning drive motor after the PWM soft start has reached the maximum current provided to the drive motor. If the boosted voltage drops below 15V, as can occur when the motor stalls or is overloaded, the MCU 50 disables the booster circuit and output control circuit. A voltage between 15-18V when the current is at its maximum is indicative of a heavy load, so the MCU reduces the PWM percentage to reduce the current to the motor to ensure that the voltage is maintained at a minimum of 16V to avoid an overload condition. If the voltage is above 20V, the MCU increases the PWM percentage until the awning drive motor is running at its maximum speed. It can be appreciated that these voltage break points are based on a boosted voltage of 24 Vdc and that the voltage break points can change for other boosted voltage values.

The MCU 50 of the controller can receive a sensor signal indicating that the awning has reached the end of its travel, whether deployed or retracted. On receipt of that signal, the MCU can disable the booster circuit 55 and the output control circuit 65, even if the user is still actuating the switch 20. Alternatively, as noted above, the MCU can use the current measurement circuit 60 to determine an increase in current due to an increased load, as would occur when the awning reaches the end of its travel.

The controller 11 can be integrated into an existing wall-mounted switch for activating the awning drive motor, as shown in FIGS. 2-5. Alternatively, a new switch, like switch 20, can replace an existing control switch, in addition to the controller 11. In some RVs, the awning control switch is in the RV cabin or on a command panel. In that case, the controller 11 need not be mounted in a switch opening O, but can instead be mounted in any appropriate location in the RV.

The present disclosure should be considered as illustrative and not restrictive in character. It is understood that only certain embodiments have been presented and that all changes, modifications and further applications that come within the spirit of the disclosure are desired to be protected.

What is claimed is:

1. An improvement for a recreational vehicle (RV) having an electrical system and an RV power supply to power the electrical system at an RV voltage, and one or more motorized awning systems, each awning system having an extendable awning, a motor for extending the awning, and a user-actuated switch for activating the motor, the improvement comprising a motor controller connecting the RV power supply, the motor and the user-actuated switch, the motor controller including:
a booster circuit connected to said power supply and configured to increase the RV voltage to a boosted voltage signal at a booster output;
an output control circuit connecting the booster output to the drive motor, the output control circuit controlled by a pulse-width modulated (PWM) signal to control the current provided to the output motor; and
a microprocessor control unit (MCU) connected to the user-actuated switch and configured to provide the PWM signal to the output control circuit when and as long as the switch is actuated by the user, wherein the PWM signal is adapted to linearly increase the current from zero amps to a maximum current for the RV electrical system within a predetermined time interval and to maintain the maximum current during the operation of the drive motor.

2. The improvement of claim 1, wherein:
the MCU generates an enable signal when and as long as the switch is actuated by the user; and
said booster circuit includes a microprocessor configured to enable the booster circuit only as long as the enable signal is received from said MCU.

3. The improvement of claim 2, wherein:
the motor controller further includes a current measurement circuit that measures the current of the boosted voltage signal at the booster output, compares the measured current to a maximum allowable current and generates a control signal provided to the MCU if the measured current exceeds the maximum allowable current; and
said MCU is configured to terminate the PWM signal provided to the output control circuit to disable the output control circuit and to terminate the enable signal provided to the microprocessor of the booster circuit to disable the booster circuit.

4. The improvement of claim 2, wherein:
the motor controller further includes a thermistor that generates a temperature signal indicative of the temperature of one or more components of the motor controller; and
the MCU is configured to compare the temperature signal to a threshold temperature value and to terminate the PWM signal provided to the output control circuit to disable the output control circuit and to terminate the enable signal provided to the microprocessor of the booster circuit to disable the booster circuit.

5. The improvement of claim 1, wherein the predetermined time interval is one (1) second.

6. An improvement for a recreational vehicle (RV) having a power supply and electrical system, and one or more motorized awning systems, each awning system having an extendable awning, a drive motor for extending the awning, and a user-actuated switch for activating the motor in which the switch is mounted within a switch opening formed in an outer wall of the RV, the improvement comprising a motor controller including:
wiring to connect to the motor controller to the power supply, the switch and the drive motor;
a microprocessor control unit (MCU) and electrical circuits configured to control the electrical power provided to the drive motor; and
a housing containing the MCU and electrical circuits, the housing including a mounting bracket at a top end of the housing that is configured to rest on a lower ledge of the switch opening when the switch is mounted within the switch opening.

6. The improvement of claim 5, wherein said housing includes radiator fins projecting from an outer surface of the housing to dissipate heated generated by the MCU and electrical circuits within the housing.
